(19) United States
(12) Patent Application Publication
(10) Pub. No.: US 2025/0070442 A1
(43) Pub. Date: Feb. 27, 2025

(54) RECONFIGURABLE FLAT DIELECTRIC STACK LENS FOR AZIMUTH BEAMWIDTH TUNING

(71) Applicant: JOHN MEZZALINGUA ASSOCIATES, LLC., Liverpool, NY (US)

(72) Inventors: Charles BUONDELMONTE, Wellington, FL (US); Lance BAMFORD, Pittsford, NY (US); Ananta Venkata Uday Kiran KANDALA, Hyderabad (IN)

(21) Appl. No.: 18/814,122

(22) Filed: Aug. 23, 2024

Related U.S. Application Data
(60) Provisional application No. 63/578,680, filed on Aug. 25, 2023.

(51) Int. Cl. H01P 3/20; H01P 1/06

(52) U.S. Cl. CPC H01P 3/20; H01P 1/061

(57) ABSTRACT

A C-Band array is formed of beamwidth-controlled radiator column. Each beamwidth-controlled radiator columns comprises a plurality of radiators; and a reconfigurable lens disposed over the plurality of radiators, wherein the reconfigurable lens has a bottom layer that has a plurality of bottom layer holes, and a middle layer that has two middle layer sections that are separated along an azimuth axis by a gap, and wherein the reconfigurable lens has one or more beamwidth control sliders that are configurable to translate along a vertical axis, wherein the reconfigurable lens is formed of a dielectric material. By translating the beamwidth control sliders, one can adjust the azimuth beamwidth of the radiators. This may be done remotely after the antenna is deployed, to adjust for optimal beamwidth in the presence of interferers.

### CROSS-REFERENCE TO RELATED APPLICATIONS

This application claims the benefit of U.S. Provisional Application No. 63/578,680, filed on Aug. 25, 2023, all of which are incorporated by reference in their entirety herein.

### BACKGROUND OF THE INVENTION

A trend in modern cellular communications involves the densification of antenna deployments. One example is in a dense urban area, where antennas may be placed in close proximity to each other to handle a high density of cellular traffic. Such densification can cause complications whereby coverage areas of nearby antennas overlap, causing interference between the antennas.

A challenge with antenna densification is that the margins of error are unforgiving. In order to prevent dead spots between antenna coverage areas, it is necessary to have some minor degree of overlap between adjacent coverages. However, excessive overlap can cause interference problems. And once deployed, it is difficult to undo the overlap.

Accordingly, what is needed is a mechanism by which azimuthal coverage of deployed antennas may be remotely adjusted to reduce the amount of overlap while maintaining consistent coverage between adjacent cells.

### SUMMARY OF THE INVENTION

An aspect of the disclosure involves a beamwidth-controlled radiator column. The beamwidth-controlled radiator column comprises a plurality of radiators; and a reconfigurable lens disposed over the plurality of radiators, wherein the reconfigurable lens has a bottom layer that has a plurality of bottom layer holes, and a middle layer that has two middle layer sections that are separated along an azimuth axis by a gap, and wherein the reconfigurable lens has one or more beamwidth control sliders that are configurable to translate along a vertical axis, wherein the reconfigurable lens is formed of a dielectric material.

Another aspect of the disclosure involves a reconfigurable dielectric lens for a plurality of radiators. The lens comprises, among other things, a plurality of dielectric layers configured to be positioned over the plurality of radiators along an axis perpendicular to an azmuthal plane associated with the plurality of radiators. The lens also comprises a beamwidth control slider configured to translate, in a positive and negative direction along the axis perpendicular to an azmuthal plane associated with the plurality of radiators, and extend in the positive direction beyond the dimensions of the plurality of dielectric layers and reduce the beamwidth of the plurality of radiators.

### BRIEF DESCRIPTION OF DRAWINGS

FIG. 1A illustrates a beamwidth-controlled column of C-Band radiators having an exemplary reconfigurable flat lens disposed over it according to the disclosure.

FIG. 1B is a view similar to FIG. 1A, but with the feedboard removed to better illustrate the radiators and the exemplary reconfigurable flat lens.

FIG. 2A is a top-down view of an exemplary reconfigurable lens, configured for maximum beamwidth.

FIG. 2B is a top-down view of the exemplary reconfigurable lens of FIG. 2A, configured for a 2-3 degree reduction in beamwidth.

FIG. 2C is a top-down view of the exemplary reconfigurable lens of FIG. 2A, configured for a 5-6 degree reduction in beamwidth.

FIG. 3A illustrates an exemplary bottom layer of a reconfigurable lens according to the disclosure.

FIG. 3B illustrates an exemplary middle layer of a reconfigurable lens according to the disclosure.

FIG. 3C illustrates an exemplary top layer of a reconfigurable lens according to the disclosure.

FIG. 3D illustrates an exemplary pair of beamwidth control sliders of a reconfigurable lens according to the disclosure.

### DETAILED DESCRIPTION OF THE INVENTION

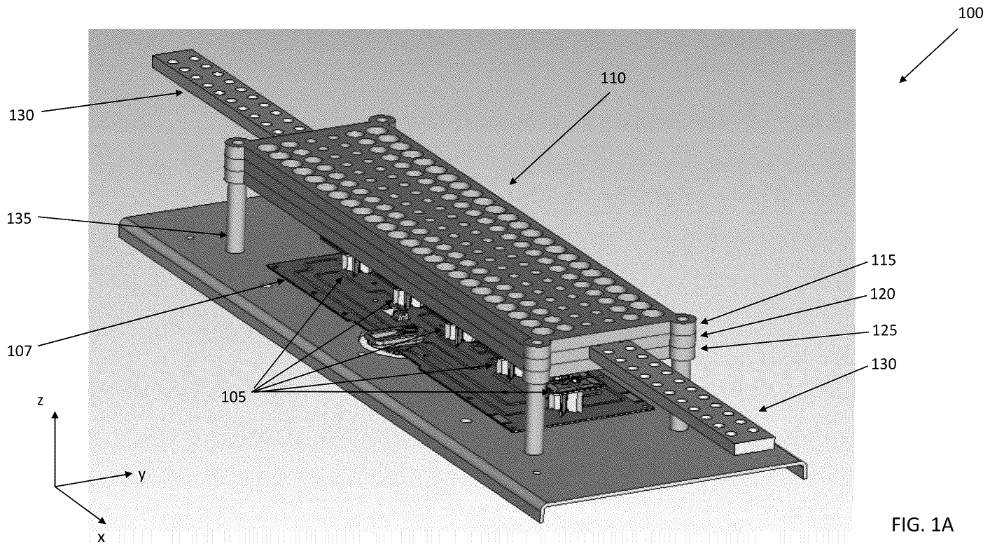

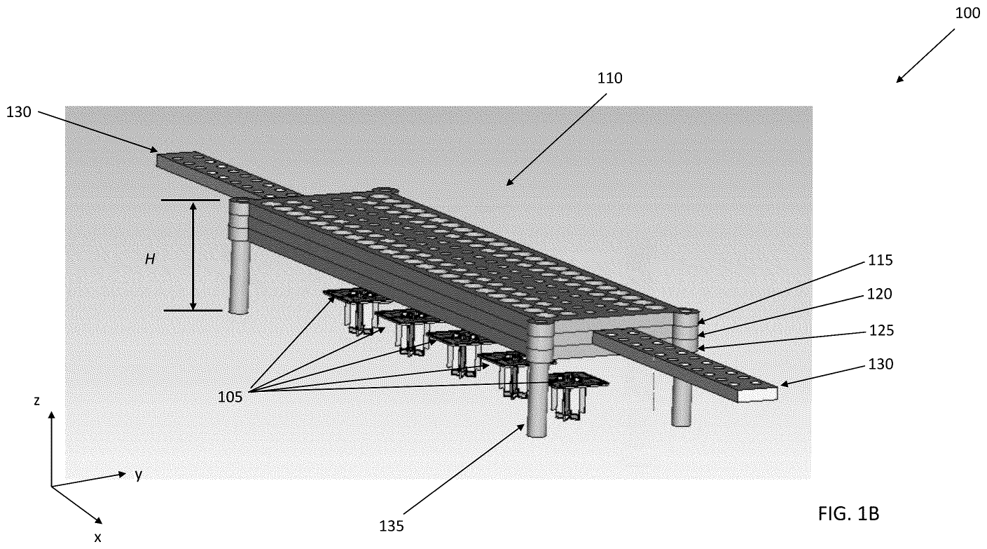

FIG. 1A illustrates a beamwidth-controlled C-Band (3.4-4.2 GHz) column 100 according to the disclosure. Beamwidth-controlled C-Band Column 100 has a plurality of C-Band radiators 105 that are coupled to a feedboard 107. Disposed above the C-Band radiators 105 is an exemplary reconfigurable flat lens (hereinafter “flat lens”) 110, which may be used to control the azimuth beamwidth of the beam formed by C-Band radiators 105. As illustrated, the azimuth plane may be defined by the z-axis and the y-axis in FIG. 1A. Flat lens 110 has a top dielectric layer 115; a middle dielectric layer 120; and a bottom dielectric layer 125. Disposed coplanar with middle dielectric layer 120 are two beamwidth control sliders 130 that are configured so that they may translate in the positive and negative x-axis direction to control the beamwidth of the radiated beam in the azimuth plane. Top dielectric layer 115, middle dielectric layer 120, and bottom dielectric layer 125 may be supported by legs 135, which may be formed integral to and of the same material as bottom dielectric layer 125.

FIG. 1B is a similar illustration as FIG. 1A, but with feedboard 107 removed to more clearly illustrate C-Band radiators 105.

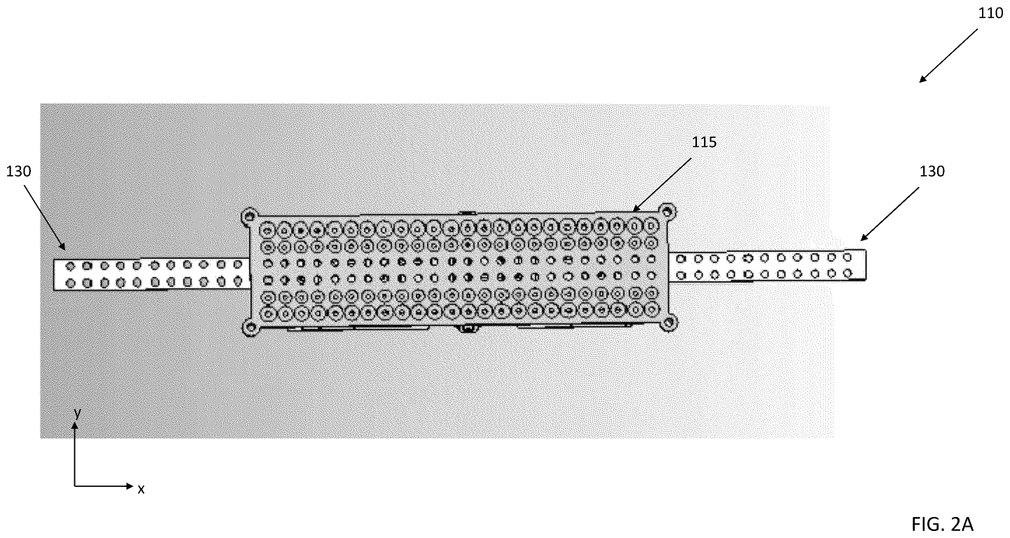

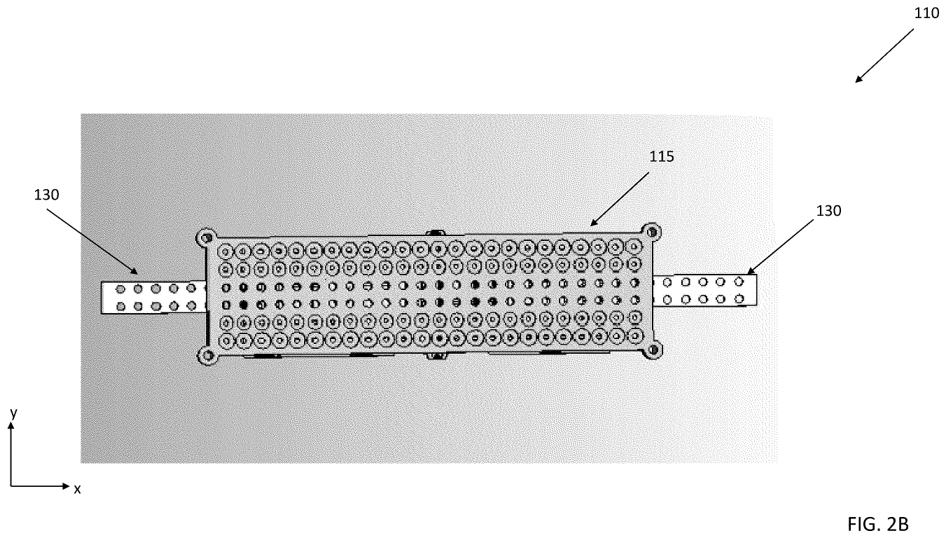

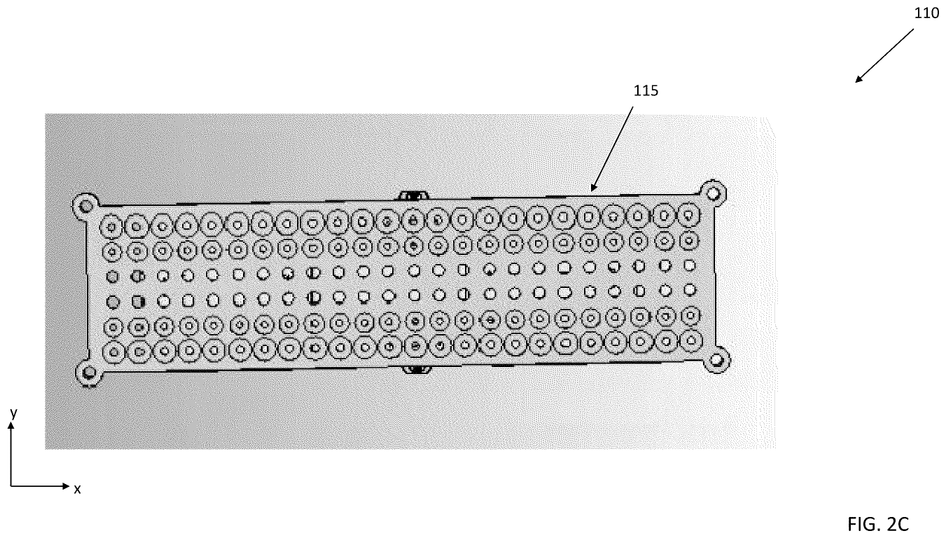

FIG. 2A is a top-down view of an exemplary flat lens 110, configured for maximum beamwidth. As illustrated, the two beamwidth control sliders 130 are translated outward from the center of flat lens 110 respectively in the positive and negative x-axis direction. With them in this configuration, beamwidth control sliders 130 are removed as far as possible from the energy radiated by C-Band radiators 105 and thus minimally contribute to the refraction of the beam imparted by flat lens 110.

Beamwidth control sliders 130 are configured to translate along the x-axis. Given that it's a top-down view (along the negative z-axis), only the top layer 115 of the three layers is visible in the drawing. In an exemplary embodiment, the maximum beamwidth may be 48 degrees.

Without the presence of exemplary flat lens 110 the single column of C-Band radiators 105 has a 3 dB azimuth beamwidth (z-y plane) of approximately 65 to 70 degrees. Conventional methods of controlling the 3 dB azimuth beamwidth are available but would require multiples of C-Band radiator columns disposed along the y-axis direction. The use of exemplary flat lens 110 may eliminate the need for multiple radiator columns, thereby reducing complexity, antenna size and cost while providing the necessary 3 dB azimuth beamwidth reduction. Further, conventional methods for controlling azimuth beamwidth do not provide the ability to remotely vary the antenna's 3 dB azimuth beamwidth after it has been installed.

Each of the beamwidth control sliders 130 may have a length (in the x-axis direction) that is one half the length of top layer 115. Exemplary dimensions are discussed below. In an exemplary embodiment, each beamwidth control slider 130 may have a length of 159.1 mm and a width of 23 mm. Each beamwidth control slider 130 may be formed of a high k dielectric material, in this case a dielectric constant of approximately 10. An example material may be TMM10i, offered by Rogers Corporation, which has a dielectric constant of 9.80+/−. 245. As used herein, “approximately 10” may mean within the range of 9.8+/−. 245.

Beamwidth control sliders 130 may be caused to translate by use of translational electric motors, similar to those used for Remote Electrical Tilt (RET) systems used in macro cellular antennas. It will be understood that implementations of the translation mechanism and variations thereof are possible and within the scope of the disclosure.

FIG. 2B is a top-down view of the exemplary flat lens 110, configured for a 2-3 degree reduction in beamwidth. In this exemplary configuration, beamwidth control sliders 130 are positioned at a midway point between fully stowed under top layer 115 and fully extended outward as illustrated in FIG. 2A. In this configuration, the C-Band radiators 105 may radiate with a beamwidth in the azimuth plane that is reduced. In an exemplary embodiment in which the unrestrained beamwidth is 48 degrees, the beamwidth in this configuration may be reduced to 44 degrees.

FIG. 2C is a top-down view of the exemplary flat lens 110, configured for a 5-6 degree reduction in beamwidth. In this configuration, both beamwidth control sliders 130 are fully retracted and stowed under top layer 115. With the beamwidth control sliders 130 fully retracted under top layer 115, the beam refraction imparted by beamwidth control sliders 130 is at its maximum extent. In an exemplary embodiment in which the unrestrained beamwidth is 48 degrees, the beamwidth in this configuration may be reduced to 38 degrees.

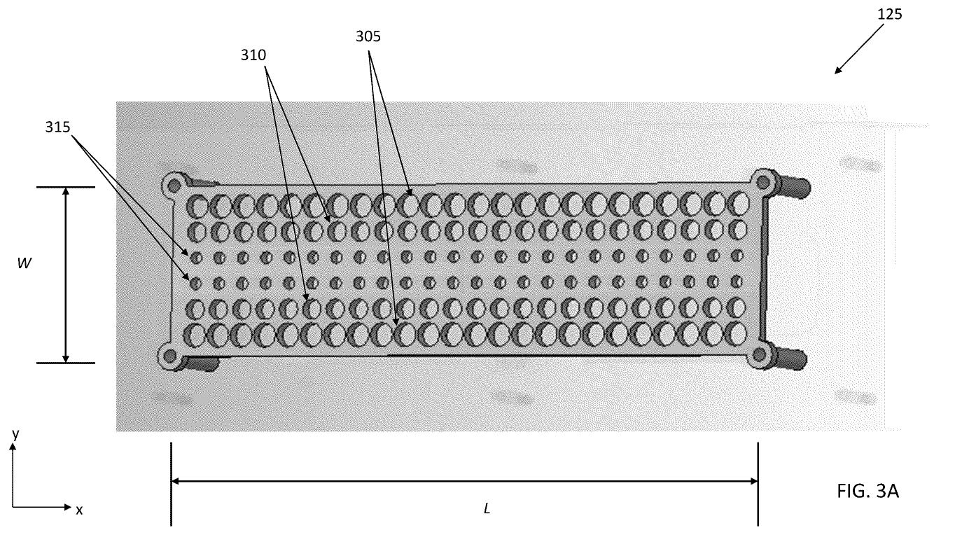

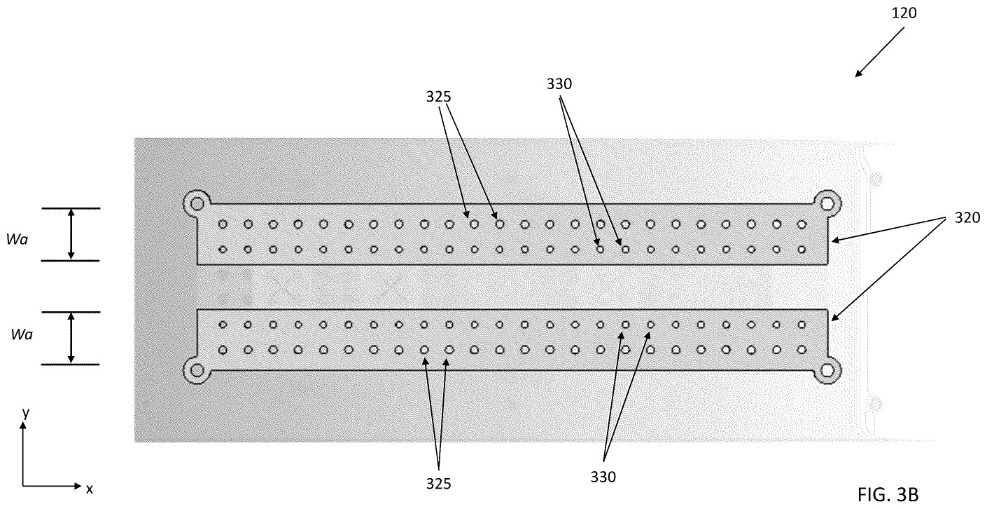

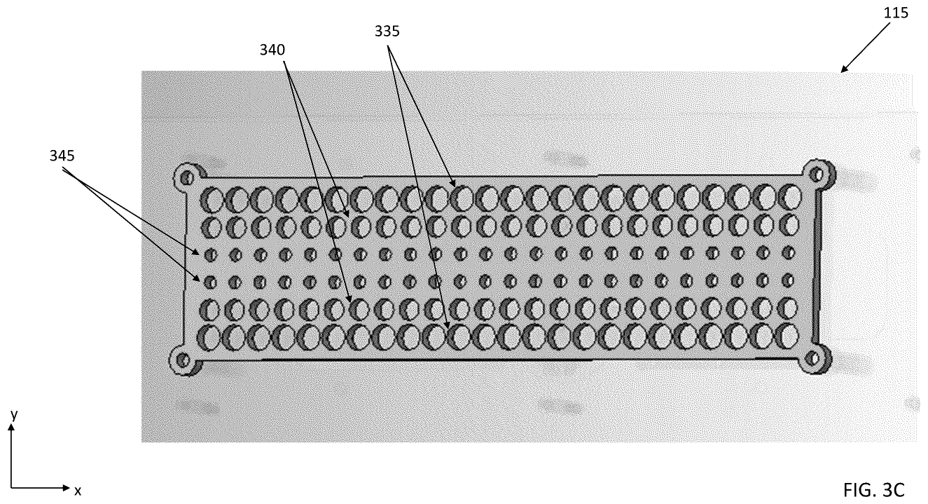

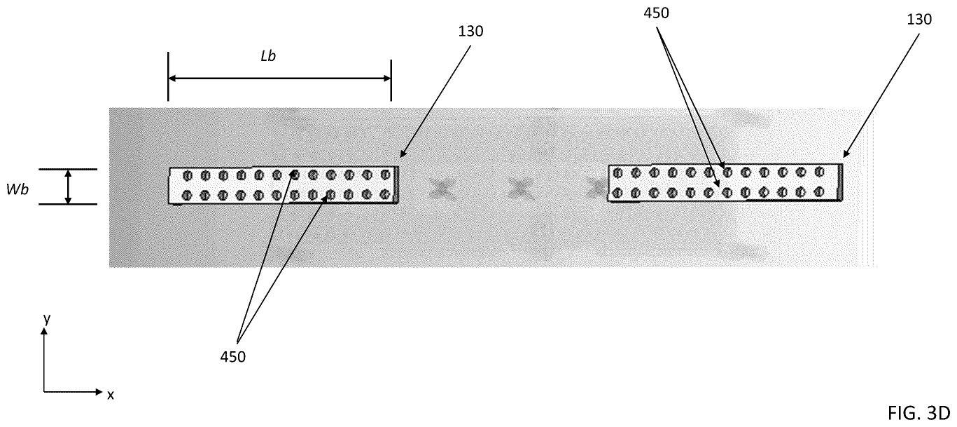

FIG. 3A illustrates exemplary bottom layer 125 of flat lens 110 according to the disclosure. Flat lens may be formed of a dielectric substrate that has a plurality of holes of different diameters, arranged in columns along the vertical (x-axis) direction. The outermost holes, or plurality of first holes 305 on either end along the y-axis direction have a first diameter that is the greatest diameter of the holes. The next set of holes along y-axis inward toward the center of bottom layer 125, is a plurality of second holes 310 that have a second diameter that is less than the first diameter. Inward along the y-axis from the plurality of second holes is a plurality of third holes 315, which have a third diameter that is the smallest diameter of the holes in bottom layer 125. Accordingly, bottom layer 125 has a plurality of holes arranged in columns such that the outermost columns of holes have the greatest diameter, and the center columns of holes have the smallest diameter.

The location, diameter, and spacing of the holes disclosed herein may be predetermined to locally and artificially reduce the dielectric constant of the layers 115/120/125 and sliders 130, allowing the designer to spatially adjust the dielectric constant of each of the components.

In an exemplary embodiment, the first diameter (of the outermost holes 305) may be 12 mm; second diameter (of holes 310) may be 10 mm; and third diameter (of innermost holes 315) may be 6 mm. Further to an exemplary embodiment, bottom layer 125 may be formed of materials with a dielectric constant of approximately 3 such as ABS (Acrylonitrile butadiene styrene), which has a dielectric constant of 2.6-3.3 with an average value of 2.9., and may have a thickness of 6.7 mm; a length L of 318. mmm; and a width W of 84 mm. It will be understood that these dimensions are exemplary and that variations to these dimensions are possible and within the scope of the disclosure.

FIG. 3B illustrates an exemplary middle layer 120 of flat lens 110 according to the disclosure. Middle layer 120 has two sections 320 that mount to the legs 135 of bottom layer 125. Between the two sections 320 is a gap within which beamwidth control sliders 130 (not shown) are disposed such that they may translate along the x-axis direction. Sections 320 may have a width Wa that in an exemplary embodiment may be 30.4 mm. Disposed within sections 320 are a plurality of first holes 325 that are disposed along the x-axis direction and closer to the outer edge of respective section 320 along the y-axis; and a plurality of second holes 330 that are disposed along the x-axis and located along an inner edge of respective section 320 along the y-axis. In an exemplary embodiment, each of the plurality of first holes 325 may have a diameter of 4.0 mm; and each of the plurality of second holes 330 may have a diameter of 3.3 mm. Sections 320 of middle layer 120 may be formed of materials with a dielectric, constant of approximately 3 such as ABS (Acrylonitrile butadiene styrene), which has a dielectric constant of 2.6-3.3 with an average value of 2.9. As used herein, the term “approximately 3” means in the range of 2.6-3.3. and have a thickness of 6.7 mm. It will be understood that these dimensions are exemplary and that variations are possible and within the scope of the disclosure.

FIG. 3C illustrates top layer 115 of flat lens 110 according to the disclosure. Top layer 115 may have the same width and length as bottom layer 125. Top layer 115 has a plurality of first holes 335 that are disposed along the x-axis direction and are located closest to the outer edges of top layer 115 along the y-axis direction. Each of the plurality of first holes 335 may have the same diameter and placement as the first holes 305 of bottom layer 125. Located inward along the y-axis direction from and adjacent to the plurality of first holes 335 is a plurality of second holes 340. Each of the plurality of second holes 340 may have the same diameter and placement as the plurality of second holes 310 of bottom layer 125. Located inward and adjacent to the plurality of second holes 340 is a plurality of third holes 345. Each of the plurality of third holes 345 may have the same diameter and placement as the plurality of third holes 315 of bottom layer 125. Accordingly, top layer 115 has a plurality of holes arranged in columns such that the outermost columns of holes have the greatest diameter, and the center columns of holes have the smallest diameter.

FIG. 3D illustrates an exemplary pair of beamwidth control sliders 130 of flat lens 110 according to the disclosure. Each beamwidth control slider 130 may be formed of the same material as middle layer 120 and have a plurality of holes 450. In an exemplary embodiment, each beamwidth control slider 130 may have a length of 159.1 mm and a width of 23 mm. Each beamwidth control slider 130 may be formed of materials with a dielectric constant of approximately 10 such as Roger's Corporation TMM10i laminate material.

Variations to flat lens are possible. For example, the holes illustrated in the Figures may be rectangular or of other shapes than circular. Further, the dimensions of the holes in a given column may not be uniform, although generally the outermost columns of holes have the greatest average dimension, and the center columns of holes have the smallest average dimension. In another variation, the holes might not be aligned between bottom and top layer.

Although FIGS. 1A and 1B show exemplary flat lens 110 disposed over a column of 5 C-Band radiators 107, more or fewer C-Band radiators may be used. In this case, the length of flat lens 110 may be changed to accommodate the longer or shorter column of C-Band radiators 105. Further, multiple beamwidth-controlled C-Band columns 100 may be deployed in a single array face. For example, multiple beamwidth-controlled C-Band columns 100 may be placed in sequence along the azimuth or y-axis direction. Additionally, multiple beamwidth-controlled C-Band columns 100 may be deployed along the x-axis direction, provided that there are sufficient gaps between corresponding flat lenses 110 so that their respective beamwidth control sliders 130 have sufficient space to translate outward for maximum beamwidth. In another possible variation, instead of having two stationary layers (top layer 115 and bottom layer 125), flat lens 110 may have a single stationary layer (e.g., bottom layer 125) and middle layer 120 with beamwidth control sliders 130. In this case the thickness of each layer and the shape, dimensions, and arrangement of holes may change accordingly.

Although the discussion has related to an exemplary embodiment involving C-Band radiators 105. It will be understood that flat lens 110 and its components and features may be scaled to provide beamwidth control for radiators of different frequency bands, and that such variations are possible and within the scope of the disclosure. For example, scaling the dimensions of flat lens 110 and its components by a factor of 1.2 to 1.4 may provide similar performance in the midband (1695-2690 MHz).

While the exemplary embodiments described above and illustrated in the figures involve two beamwidth control sliders 130, as was also stated above, it is within the scope of this disclosure for the flat lens to employ a one single beamwidth slider that translates in both positive and negative directions along the illustrated x-axis. Like the embodiments described above, a single beamwidth slider may be controlled by an electric motor that, in turn, is controlled remotely by wired or wireless connection.

Still further, it will be appreciated by those skilled in the art that the two beamwidth control sliders 130 described above, may be controlled to translate simultaneously in equal and opposite directions along the x-axis so that the two beamwidth control sliders 130 extend at equal lengths from under the top layer 115 of the flat lens 110. Alternatively, the two beamwidth control sliders 130 may be controlled independent of one another such that the two beamwidth control sliders 130 extend at different lengths from under the top layer 115 of the flat lens 110, or one of the two beamwidth control sliders 130 may extend from under the top layer 115 of the flat lens 110, while the other of the two beamwidth control sliders 130 remains fully retracted under the top layer 115 of the flat lens 110.

As those skilled in the art will further appreciate, still other variations are possible and considered within the scope and spirit of the present disclosure.

1. A beamwidth-controlled radiator column, comprising:
a plurality of radiators; and
a reconfigurable lens disposed over the plurality of radiators, wherein the reconfigurable lens has a bottom layer that has a plurality of bottom layer holes, and a middle layer that has two middle layer sections that are separated along an azimuth axis by a gap, and wherein the reconfigurable lens has one or more beamwidth control sliders that are configurable to translate along an axis perpendicular to an azmuthal plane of the beamwidth-controlled radiator column, wherein the reconfigurable lens is formed of a dielectric material.

2. The beamwidth-controlled radiator column of claim 1, wherein each of the two middle layer sections comprises a plurality of middle layer holes.

3. The beamwidth-controlled radiator column of claim 1, wherein the one or more beamwidth control sliders comprise a plurality of slider holes.

4. The beamwidth-controlled radiator column of claim 1, wherein the plurality of bottom layer holes comprises:
a first column of first bottom holes disposed along the vertical axis along a bottom layer outer edge, the first bottom holes having a first diameter;
a second column of second bottom holes disposed adjacent to the first column of first bottom holes, the second bottom holes comprising a second diameter; and
a third column of third bottom holes disposed adjacent to the second column of second bottom holes, the third column of third bottom holes comprising a third diameter, wherein the first diameter is greater than the second diameter, and the second diameter is greater than the third diameter.

5. The beamwidth-controlled radiator column of claim 1, wherein the reconfigurable lens further comprises a top layer having a plurality of top layer holes.

6. The beamwidth-controlled radiator column of claim 1, wherein the plurality of top layer holes comprises:
a first column of first top holes disposed along the vertical axis along a bottom layer outer edge, the first top holes having a first diameter;
a second column of second top holes disposed adjacent to the first column of first top holes, the second top holes comprising a second diameter; and
a third column of third top holes disposed adjacent to the second column of second top holes, the third column of third top holes comprising a third diameter, wherein the first diameter is greater than the second diameter, and the second diameter is greater than the third diameter.

7. The beamwidth-controlled radiator column of claim 1, wherein the bottom layer and the top layer comprise a dielectric constant of approximately 3.

8. The beamwidth-controlled radiator column of claim 7, wherein the bottom layer and the top layer comprise ABS (Acrylonitrile butadiene styrene).

9. The beamwidth-controlled radiator column of claim 7, where in the beamwidth control sliders comprise a dielectric constant of approximately 10.

10. The beamwidth-controlled radiator column of claim 9, wherein the beamwidth control sliders comprise a TMM10i material.

11. The beamwidth-controlled radiator column of claim 1 further comprising:
a motor configured to cause the one or more beamwidth control sliders along the axis perpendicular to the azmuthal plane of the beamwidth-controlled radiator column.

12. A reconfigurable dielectric lens for a plurality of radiators, the lens comprising:
a plurality of dielectric layers configured to be positioned over the plurality of radiators along an axis perpendicular to an azmuthal plane associated with the plurality of radiators;
a beamwidth control slider configured to translate, in a positive and negative direction along the axis perpendicular to an azmuthal plane associated with the plurality of radiators, and extend in the positive direction beyond the dimensions of the plurality of dielectric layers and reduce the beamwidth of the plurality of radiators.

13. The reconfigurable dielectric lens of claim 12 further comprising:
a second beamwidth control slider configured to translate, in a positive and negative direction along the axis perpendicular to the azmuthal plane associated with the plurality of radiators, and extend beyond the dimensions of the plurality of dielectric layers in the negative direction and reduce the beamwidth of the plurality of radiators.

14. The reconfigurable dielectric lens of claim 13, wherein the beamwidth control slider and the second beamwidth control slider are further configured to translate simultaneously in equal and opposite directions along the axis perpendicular to the azmuthal plane associated with the plurality of radiators, and to extend an equal distance beyond the dimensions of the plurality of dielectric layers.

15. The reconfigurable dielectric lens of claim 13, wherein the beamwidth control slider and the second beamwidth control slider are further configured to translate simultaneously in a same direction along the axis perpendicular to the azmuthal plane associated with the plurality of radiators, and to extend at different distances, respectively, beyond the dimensions of the plurality of dielectric layers.

16. The reconfigurable dielectric lens of claim 13, wherein the beamwidth control slider and the second beamwidth control slider are further configured to translate along the axis perpendicular to the azmuthal plane associated with the plurality of radiators independ of each other.

17. The reconfigurable dielectric lens of claim 13, wherein one of the beamwidth control slider and the second beamwidth control slider is further configured to not extend beyond the dimensions of the plurality of dielectric layers at the same time the other one of the beamwidth control slider and the second beamwidth control slider extends beyond the dimensions of plurality of dielectric layers.

18. The reconfigurable dielectric lens of claim 12, wherein the translation of the beamwidth control slider is controlled by an electric motor, and wherein the electric motor is controlled remotely by wired or wireless connection.

19. The reconfigurable dielectric lens of claim 18, wherein the translation of the second beamwidth control slider is controlled by an electric motor, wherein the electric motor is controlled remotely by wired or wireless connection.

20. The reconfigurable dielectric lens of claim 19, wherein the electric motor that controls the beamwidth control slider and the electric motor that controls the second beamwidth control slider are the same motor.
